(19) United States
(12) Patent Application Publication
(10) Pub. No.: US 2008/0175650 A1
(43) Pub. Date: Jul. 24, 2008

(54) Combined Toy and Writing Instrument or Other Article

(76) Inventor: William Thomas GEDDES, Cockeysville, MD (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/625,265

(22) Filed: Jan. 19, 2007

(51) Int. Cl. B43K 29/00

(52) U.S. Cl. 401/195

(57) ABSTRACT

A toy is combined with a writing instrument, a key chain, or a container. The writing instrument and key chain each have a cylindrical body, a groove formed on at least a portion of an outside surface of the cylindrical body that coils around the circumference of the cylindrical body, and a moveable element having an extension slideably disposed in the groove on the cylindrical body, whereby the element moves along the cylindrical body circumference within the groove. The writing instrument has a writing tip extending from an end of the cylindrical body. The key chain has a key ring connected to an end of the cylindrical body. The container has a hollow elongated cylindrical body, a groove formed on at least a portion of an outside surface of the cylindrical body, and a moveable element disposed in the groove on the cylindrical body, and an item disposed in the hollow cylindrical body. The element is moveable within the groove and coils around the cylindrical body circumference.

### BACKGROUND OF THE INVENTION

1. Field of the Invention

The present invention relates to novelty items. More particularly, the present invention relates to novelty items such as writing instruments, containers, such as for candy, key chains, and other such items.

2. Background Art

An everyday useful item or article may also provide entertainment and aesthetic value by virtue of its combination with a toy. For example, a toy figure may be provided on a pacifier to increase the pacifier's appeal to a child. Similarly, writing instruments may be combined with toys that may be manipulated by a user during use. The combination of toys with useful items make these items more popular and fun to use. One way which is known in the art to make a writing instrument more pleasing is to combine it with something that is amusing, such as a figurine, or something that moves when the pen is in use, such as an item that is suspended in liquid that moves inside a barrel of the writing instrument, from one end of the barrel to the other when the pen is tipped upside down. The inventor has found that an even more enjoyable writing instrument can be made when the item is a figurine, and the figurine moves along the outside of the barrel in a spiral configuration, spinning along the barrel exterior.

Switzerland Patent No. CH630264, describes a toy having a climber connected to a wooden bead by a spring. A wire vertically extends from a base and is inserted through a bore of a wooden bead. The bore of the wooden bead has a groove extending obliquely to the axis of the bore, causing rotation during a downward movement of the climber. While this toy provides amusement, it does not provide any useful function such as a writing instrument does. Further, vibration of the spring, and not gravity, causes the climber to descend the spring, which would not be conducive in a writing instrument or other useful article.

U.S. Pat. No. 2,149,677 describes a similar toy in which a vertical rod, mounted upon a base support, extends through a tubular coil carrying a figure toy. Vibratory movement causes the coil to creep slowly downwardly upon the vertical rod and also to rotate on the vertical rod to impart a circulatory movement to the figure toy. The rod itself is not threaded, and vibrations of the spring, and not gravity, cause the climber to descend.

U.S. Pat. No. 2,149,677 also describes a toy having a vertical threaded rod supported by a horizontal heavy disk block base. A symmetrical bracket engages with the thread of the rod and carries a figure toy representative of an aeroplane on the outer end of each bracket arm. The bracket is evenly balanced on the rod with each aeroplane laterally extending in diametrically opposite directions perpendicular to the rod. During use of the toy, the bracket threads downwardly upon the vertical threaded rod while the figure toys move through circular paths in a downward direction over the vertical rod. The bracket has a finger that engages with the threads of the rod, and therefore the aeroplanes do not descend by the force of gravity. Rather, user intervention is required to initiate movement in the downward direction.

Each of these toys discussed above are anchored to a surface by their respective bases. These toys are not combined with useful, everyday items, and if so combined, their construction to include a base support and figure toys laterally extending a substantial distance from a thin rod or wire would hinder the usefulness, and therefore the popularity, of the everyday item. Thus the need exists to improve the popularity of everyday items by effectively combining them with exciting toys. The present invention satisfies these and other needs, and provides further related advantages.

### BRIEF SUMMARY OF THE INVENTION

In one embodiment according to the present invention, a toy is combined with a writing instrument and includes a cylindrical body, a groove formed on at least a portion of an outside surface of the cylindrical body, a writing tip extending from an end of the cylindrical body, and a moveable element having an extension slideably disposed in the groove on the cylindrical body. The groove coils around the circumference of the cylindrical body, and the element moves along the cylindrical body circumference within the groove.

In other embodiment, a toy is combined with a key chain and includes a cylindrical body, a groove formed on at least a portion of an outside surface of the cylindrical body, a key ring connected to an end of the cylindrical body, and a moveable element having an extension slideably disposed in the groove on the cylindrical body. The groove coils around the circumference of the cylindrical body, and the element moves along the cylindrical body circumference within the groove.

In another embodiment, a toy is combined with a container and includes a hollow elongated cylindrical body, an item disposed in the body, a groove formed on at least a portion of an outside surface of the cylindrical body, and a moveable element disposed in the groove on the cylindrical body. The groove coils around the circumference of the cylindrical body, and the element is moveable within the groove and coils around the cylindrical body circumference.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention. In the drawings, like reference numbers, letters, or renderings indicate identical or functionally similar elements.

FIGS. 1 and 2 are front and rear perspective views, respectively, of a combined toy and writing instrument according to an embodiment of the present invention.

FIGS. 3 and 4 are front and side longitudinal cross-sectional views, respectively, of a portion of a barrel of the writing instrument of FIGS. 1 and 2, showing an extension of a moveable element being disposed in a groove and extending through the barrel.

FIG. 5 is a perspective view a portion of the barrel of the writing instrument, showing the groove coiling around the barrel circumference.

FIG. 6 is a schematic of a spiraling movement taken by the moveable element along the barrel circumference.

FIG. 7 is a perspective view of the combined toy and writing instrument according to another embodiment of the present invention.

FIG. 8 is a perspective view of the combined toy and writing instrument according to another embodiment of the present invention.

FIG. 9 is a perspective view of the combined toy and writing instrument according to another embodiment of the present invention.

FIG. 10 is a perspective view of the combined toy and writing instrument according to another embodiment of the present invention.

FIG. 11 is a perspective view of a combined toy and key chain according to another embodiment of the present invention.

FIG. 12 is a perspective view of a combined toy and container according to another embodiment of the present invention.

### DETAILED DESCRIPTION OF THE INVENTION

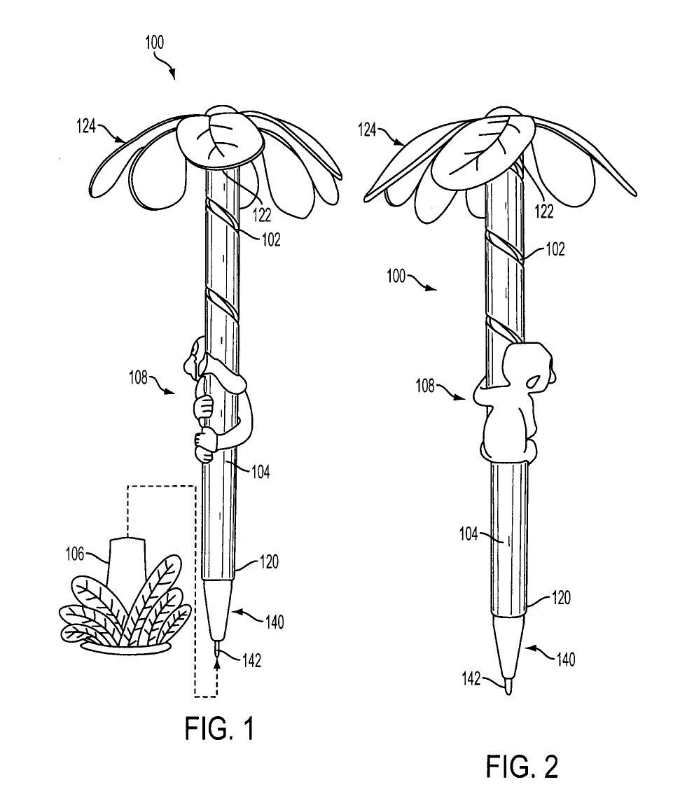

FIGS. 1 and 2 show perspective views of a combined toy and writing instrument according to an embodiment of the present invention. Any type of writing instrument may be employed in the combination, including, but not limit to, a ball point pen, highlighter, marker, roller ball pen, felt-tip pen, fountain pen, lead pencil, chalk pencil, charcoal pencil, mechanical pencil, or any other writing instrument using a fluid-based or solid-type writing medium. In FIGS. 1 and 2, writing instrument 100 has a cylindrical body 104 with a first end 120 and a second end 122. Cylindrical body 104 defines an outer exposed surface of writing instrument 100. Writing tip 140 extends from first end 120 and includes a writing nib 142, such as a ball-point nib. Writing tip 140 may taper between the cylindrical body's first end 120 to writing nib 142. In one embodiment, writing tip 140 has a diameter of about 0.9 cm adjacent cylindrical body's first end 120 and may taper to a diameter of 0.4 cm adjacent writing nib 142. A cap 106 selectively covers writing tip 140 and may also serve as a stand for writing instrument 100. In one embodiment, a length of writing instrument 100, from second end 120 to writing nib 142, may be about 20 cm, and cap 106 may have a length of about 3.5 cm. Writing instrument 100 may be refined in aesthetic appeal by making cap 106 decorative, such as shown in this embodiment, in which cap 106 is in the form of a leafy tree trunk base.

A spiraling toy is combined with writing instrument 100 and includes a moveable element 108 that moves along the circumference of cylindrical body 104, along groove 102 formed on the outer exposed surface of cylindrical body 104. Groove 102 coils around the circumference of cylindrical body 104 along at least a portion of the length of cylindrical body 104. In one embodiment, groove 102 slopes around the circumference of the cylindrical body at a constant angle of between about 35 to about 65 degrees to the horizontal, and the diameter of the cylindrical body is between about 0.4 to about 1.5 cm. For example, in one embodiment, the angle of groove 102 may be about 35 degrees to the horizontal. The diameter of the portion of cylindrical body 104 having groove 102 formed thereon may be about 1.2 cm, while the overall diameter of element 108 may be about 2.5 cm. Further, in this example, the overall length of element 108 along the length of cylindrical body 102 may be about 5 cm, while the overall length of writing instrument 100 including cylindrical body 104 and cap 106 may be between about 23 and 24 cm. Element 108 may be a figurine, such as, for example, a figurine of a character or icon known in popular culture. A figurine of an icon represents a person, place, thing, or myth. A figurine of a character resembles a fictional or non-fictional being, human or otherwise. In FIG. 1, element 108 is a figurine 108 resembling a monkey. A decorative member 124 may extend from second end 122 of cylindrical body 104. In this embodiment, decorative member 124 is a canopy of leaves. Tree trunk cap 106 and canopy of leaves 124 makes writing instrument 100 resemble a tree, so as to provide the entertaining appearance that monkey figurine 108 is ascending and descending a tree when it coils around cylindrical body 104 in groove 102.

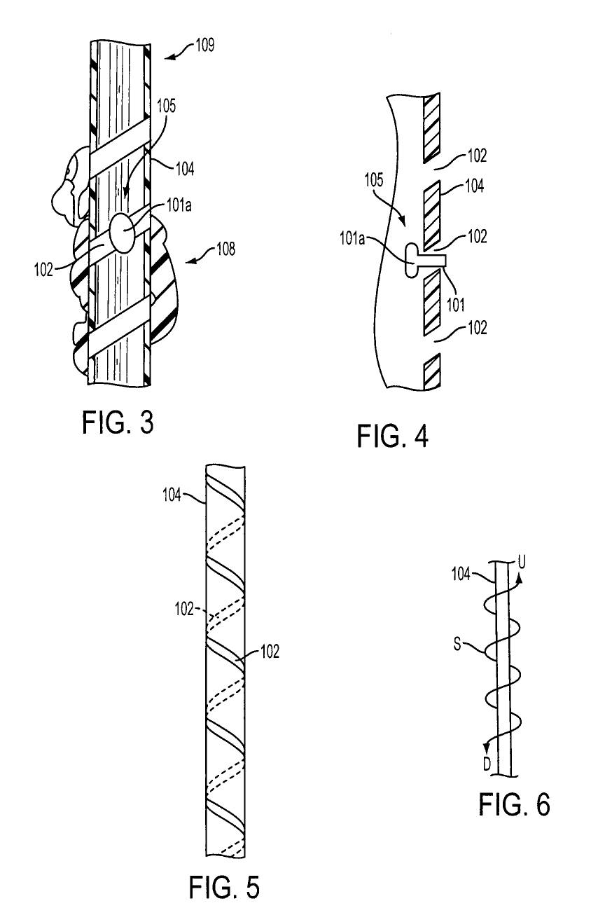

As shown in FIGS. 3 and 4, figurine 108 includes an interior extension 101 that is slideably disposed in groove 102. In one embodiment, cylindrical body 104 is hollow and forms a barrel 104, and groove 102 is a cutout in barrel 104 that extends from an exterior 109 to an interior 105 of barrel 104. As shown in FIG. 4, edges of groove 102 may be angled from the horizontal between exterior 109 to interior 105 of barrel 104. Extension 101 is loosely disposed in groove 102 so that figurine 108 easily spirals around the barrel by the force of gravity. In this embodiment, extension 101 may be in the form of a peg that projects from a main body of figurine 108 (such as from the chest of the monkey in FIG. 3) into interior 105 of barrel 104. To help retain extension 101 in groove 102 and figurine 108 on barrel 104, extension 101 may include an enlarged head 101a that is larger in size than a size of groove 102.

In operation, extension 101 easily slides in groove 102 coiling around cylindrical body 104 (see FIG. 5) when cylindrical body 104 is substantially vertical. Referring to the schematic of FIG. 6, with writing tip 140 positioned in a substantially downward direction (shown in FIGS. 1 and 2), figurine 108 takes a spiraling track S around cylindrical body 104 by the force of gravity in a direction D toward first end 120 and writing tip 140. Figurine 108 ceases moving along the cylindrical body circumference when groove 102 ends (or if an obstruction is placed in the groove). When writing instrument 100 is then positioned upside-down, with writing tip 140 in a substantially upward direction (not shown), figurine 108 coils around cylindrical body 104 along groove 102, under the force of gravity and in a direction U toward second end 122 of cylindrical body 104.

In one embodiment, figurine 108 (and any of the moveable elements describe herein) has an uneven weight distribution about the circumference of cylindrical body 104, so that the force of gravity on the unbalanced weight of figurine 108 quickens the movement of figurine 108 around the circumference of cylindrical body 104. For example, a majority of the weight of figurine 108 may be disposed about one half of the circumference of cylindrical body 104. For monkey figurine 108, the main body (and weight) of the monkey is situated about one half of the circumference of cylindrical body 104, and the remainder of the monkey (and remaining weight), i.e., its limbs, are wrapped around the remaining portion of the cylindrical body circumference. Further, the limbs of monkey figurine 108 help to retain figurine 108 on cylindrical body 104 during its spiraling movement. In this embodiment, figurine 108 is asymmetrically shaped if divided along the axis of the cylindrical body, thereby achieving the uneven weight in the material forming figurine 108. Alternatively, a moveable element may be geometrically symmetrical, but include a weight on a portion of the element to make an uneven weight distribution of the element around the cylindrical body.

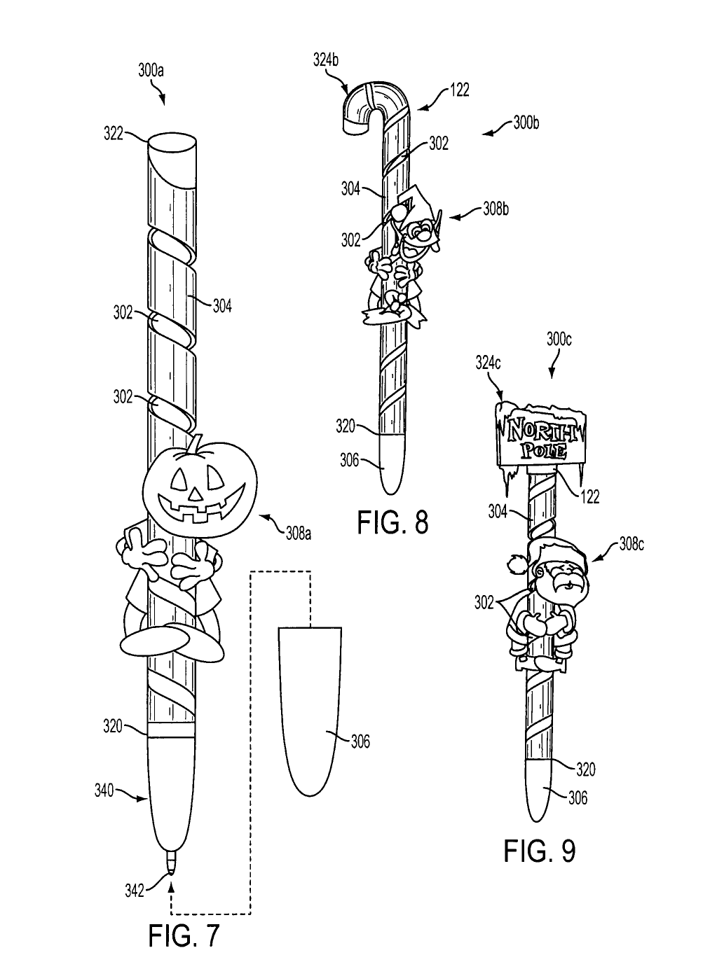

FIGS. 7, 8, and 9 illustrate other embodiments of the combined toy and writing instrument. In FIGS. 7, 8 and 9, respective writing instruments 300a, 300b, and 300b have a cylindrical body 304 with a groove 302 formed on an outside surface cylindrical body 304. Like cylindrical body 104 of writing instrument 100, each cylindrical body 304 has a first end 320 and a second end 322, with a writing tip 340 having a writing nib 342 (see FIG. 7) extending from first end 320. Writing tip 340 is selectively covered by a cap 306, which extends immediately adjacent to and may be flush with the outside surface of first end 320 of cylindrical body 304, and has an interference fit around a circumference of writing point 340. For example, in one embodiment, where writing tip 140 has a diameter of about 0.9 cm adjacent cylindrical body's first end 320, cap 306 may have an inner diameter of about 1.0 cm at its open end so as to provide an interference fit around writing point 340. Like figurine 108, each figurine 308a, 308b, and 308 include an extension (not shown) that is slideably disposed in groove 302 so that the elements may coil around their respective cylindrical bodys in a similar manner as element 108 and extension 101 described in detail above. Therefore, further description with respect to the spiraling movement of elements 308a-308c has been omitted. In FIG. 7, figurine 308a is formed as a jack-o-lantern character; in FIG. 8, figurine 308b is formed as an elf character; and in FIG. 9, figurine 308c is formed as an icon of a Santa Claus. Writing instruments 300b and 300c are further adorned with decorative members 324b (a candy can hook) and 324c (a snow-capped North Pole sign), respectively, that extend from second end 322 of respective cylindrical bodys 304. For any of the writing instruments described herein, the cylindrical body, decorative member, cap, and moveable element may be made of any sturdy material, such as translucent, transparent, or opaque plastic.

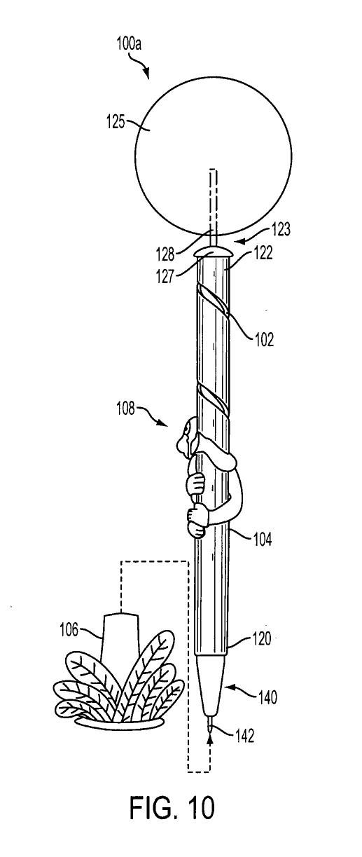

In another embodiment illustrated in FIG. 10, a writing instrument 100a has an edible item 125 attached to second end 122 of cylindrical body 104. Edible item 125 may be a candy item, such as a lollipop, as shown, or a candy-coated apple, for example. In FIG. 10, lollipop 125 is connected to cylindrical body 104 by a stick 123 having a lower portion 127 fastened to second end 122 of cylindrical body 104 and an upper elongated portion 128 adhered to lollipop 125. Stick 123 may be detached from cylindrical body 104 and discarded, which may be desired after lollipop 125 has be consumed, allowing the remainder of writing instrument 100a to be retained for use.

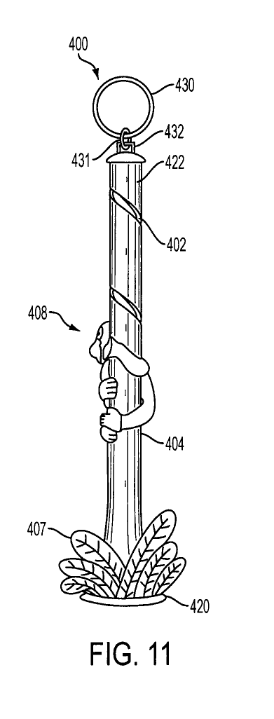

In another embodiment, a key ring is connected to second end of 122 of cylindrical body 104, similar to key ring 430 described below with reference to FIG. 11, thereby providing additional functionality to the toy and writing instrument combination.

FIG. 11 shows a combination toy and key chain according to another embodiment the present invention. As shown in FIG. 11, a key chain 400 includes a cylindrical body 404 having a first end 420 and a second end 422, and a key ring 430 that is connected to second end 422. A decorative base 402 (shown in FIG. 11 as a leafy tree trunk base) may extend from first end 420 of cylindrical body 404. Similar to writing instrument 100, key chain 400 is combined with a spiraling toy having a moveable element 408 (shown in FIG. 11 as a monkey figurine 408) that moves alongside the circumference of the cylindrical body, along a groove 402 formed on an outside surface of cylindrical body 404. Groove 402 coils around the cylindrical body circumference along at least a portion of the length of the cylindrical body. When cylindrical body 404 is substantially vertical (with first end 420 substantially above or below second end 422), figurine 408 spirals down cylindrical body 404 by the force of gravity between the ends of the cylindrical body, in a manner similar to earlier described figurines 108 and 308a-308c. Therefore, further description with respect to the spiraling movement of figurine 408 has been omitted.

In this embodiment, a key ring harness 431 is fixed to second end 422 and has a link for interlocking directly with key ring 430 or with one or more additional interlocked chain links 432. In the embodiment illustrated in FIG. 11, key ring 430 interlocks with link 432, which itself interlocks with key ring harness 431, thereby fastening key ring 430 to second end 422 of cylindrical body 404.

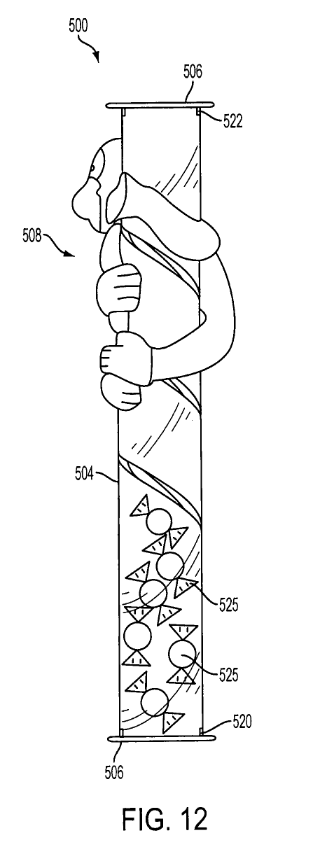

FIG. 12 shows a container 500 combined with the spiraling toy of the previously described embodiments, according to another embodiment of the present invention. Container 500 includes a hollow elongated cylindrical body 504 having a first end 520 and a second end 522. Each end of cylindrical body 504 may be closed with caps 506. One or both of caps 506 may be secured to each end of cylindrical body 502 by a press-fit, for example, so as to be selectively detached from cylindrical body 502. The hollow interior of cylindrical body 504 provides a storage space for holding one or more items, which may be edible, such as wrapped or unwrapped candy or chocolate, or may be non-edible, such as coins or a rolled-up poster. In this embodiment, wrapped candy or chocolate pieces 525 reside in cylindrical body 504. In one embodiment, cylindrical body 504 is constructed of translucent or transparent plastic to permit stored items to be seen from the exterior of the cylindrical body, as shown in FIG. 12. In another embodiment, cylindrical body is constructed of opaque plastic.

A groove 502 is formed on an outside surface of cylindrical body 504 and coils around the circumference of cylindrical body 504, along at least a portion of the length of the body. A monkey figurine 508 has an extension (not shown) slideably disposed in groove 502 so that element 508 is guided by groove 502 around cylindrical body. In one embodiment, groove 502 is a cutout that extends from an exterior to an interior of the cylindrical body 504, and the extension of figurine 508 projects into the interior of cylindrical body 504, in a similar manner as groove 102 and extension 101 discussed above with reference to FIGS. 3 and 4. In this instance, items 525 disposed in the storage space of cylindrical body 504 are of a size that prevent them from slipping out of cylindrical body 504 through groove 502. Thus, groove 502 may have a narrow width so as to ensure secure storage of the items held in the interior of cylindrical body 504. Alternatively, container 500 may include an additional, smaller cylindrical body (not shown) concentrically disposed in cylindrical body 504, with items 525 stored within the smaller cylindrical body. Monkey figurine 508 is asymmetrically shaped with a bulk of the monkey's body extending about one half of the circumference of cylindrical body 504. Thus, figurine 508 moves along cylindrical body 504 under the force of gravity when container 500 is substantially vertical (with first end 520 substantially above or below second end 522), in a similar manner as combination toy and writing instrument or key chain embodiments described above. Therefore, further description with respect to the spiraling movement of figurine 508 has been omitted.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. A writing instrument, comprising:
a cylindrical body defining an outer exposed surface of the writing instrument;
a groove formed on at least a portion of the outer exposed surface of the cylindrical body, wherein the groove coils around the circumference of the cylindrical body;
a writing tip extending from an end of the cylindrical body; and
a moveable element having an extension slideably disposed in the groove on the cylindrical body, whereby the element moves along the cylindrical body circumference within the groove.

2. The writing instrument of claim 1, wherein the element coils around the cylindrical body by the force of gravity toward the writing tip when the writing tip is positioned in a substantially downward direction.

3. The writing instrument of claim 1, wherein the element coils around the cylindrical body by the force of gravity away from the writing tip when the writing tip is positioned in a substantially upward direction.

4. The writing instrument of claim 1, wherein the cylindrical body is hollow and wherein the groove is a cutout that extends through the cylindrical body from an exterior of the cylindrical body to an interior of the cylindrical body.

5. The writing instrument of claim 4, wherein the extension of the element disposed in the groove is a peg that projects into the interior of the cylindrical body and has a head end disposed in the interior of the cylindrical body, wherein the head end of the peg is larger than the groove so as to retain the peg in the groove.

6. The writing instrument of claim 1, wherein the element has an uneven weight distribution about the cylindrical body circumference.

7. The writing instrument of claim 1, wherein the element is a figurine.

8. The writing instrument of claim 7, wherein the element is a monkey.

9. The writing instrument of claim 1, further comprising a cap for selectively covering the writing tip.

10. The writing instrument of claim 1, wherein the writing tip is a pen.

11. The writing instrument of claim 1, wherein a key ring is detachably connected to an end of the cylindrical body opposite of the writing tip.

12. The writing instrument of claim 1, wherein an edible item is detachably connected to an end of the cylindrical body opposite of the writing tip.

13. The writing instrument of claim 11, wherein the edible item is a lollipop.

14. A container, comprising:
a hollow elongated cylindrical body;
an item disposed in the body;
a groove formed on at least a portion of an outside surface of the cylindrical body, wherein the groove coils around the circumference of the cylindrical body; and
a moveable element disposed in the groove on the cylindrical body, whereby the element is moveable within the groove and coils around the cylindrical body circumference.

15. The container of claim 14, wherein the item is edible.

16. The container of claim 14, wherein the element is a character or an icon.

17. The container of claim 14, wherein the element coils around the cylindrical body by the force of gravity away from one end of the cylindrical body and toward another end of the cylindrical body when the cylindrical body is positioned substantially vertical.

18. A key chain, comprising:
a cylindrical body;
a groove formed on at least a portion of an outside surface of the cylindrical body, wherein the groove coils around the circumference of the cylindrical body;
a key ring connected to an end of the cylindrical body; and
a moveable element having an extension slideably disposed in the groove on the cylindrical body, whereby the element moves along the cylindrical body circumference within the groove.

19. The key chain of claim 18, wherein one or more interlocked chain links extend between the key ring and the end of the cylindrical body, wherein the chain links fasten the key ring to the end of the cylindrical body.

20. The key chain of claim 19, wherein the element coils around the cylindrical body by the force of gravity away from the end of the cylindrical body and toward an opposite end of the cylindrical body when the cylindrical body is positioned substantially vertical.
